(19) United States
(12) Patent Application Publication
(10) Pub. No.: US 2012/0198446 A1
(43) Pub. Date: Aug. 2, 2012

(54) Computer System and Control Method Therefor

(75) Inventors: Yuta SAWA, Fujisawa (JP); Naoya HATTORI, Yokohama (JP); Keitaro UEHARA, Machida (JP)

(73) Assignee: Hitachi, Ltd., Tokyo (JP)

(21) Appl. No.: 13/352,528

(22) Filed: Jan. 18, 2012

(30) Foreign Application Priority Data
Feb. 2, 2011 (JP) 2011-020359

(51) Int. Cl. G06F 9/455

(52) U.S. Cl. 718/1

(57) ABSTRACT

A hypervisor records error device information in a virtual PCI bridge, and makes error information in a device consistent with error information in a PCI bridge. A computer system includes a CPU, memory, and physical device PCI tree. In the memory, virtual machines capable of mutually independently acting, and a hypervisor that manages the virtual machines are existent. The physical device PCI tree includes physical bridges and devices. The physical bridge has a register in which information specifying the device is recorded. The virtual machine includes a virtual CPU, virtual memory, and virtual device PCI tree. The virtual device tree includes virtual bridges and virtual devices. The virtual bridge has a virtual memory space in which information specifying the virtual device in which an error has occurred is recorded. The hypervisor includes an interrupt handling program that is a virtual bridge modification program which modifies information in the virtual bridge.

### CLAIM OF PRIORITY

The present application claims priority from Japanese Patent Application JP2011-20359 filed on Feb. 2, 2011, the content of which is hereby incorporated by reference into this application.

### BACKGROUND OF THE INVENTION

1. Field of the Invention

The present invention relates to a virtualized computer system, or more particularly, to a technology for upgrading availability against an error in the virtualized computer system. An availability of computer system is time proportion that the system is in functioning state.

2. Description of the Related Art

As background technologies for the field of the present technology, for example, the PCI-specification advanced error reporting (AER) (refer to PCI Express Base 2.1 Specification, Section 7.10) is cited. According to the technology, once an error occurs in an input/output (I/O) device, a bus/device/function (BDF) value which specifies the error detected I/O device is recorded in plural PCI bridges disposed on the way. Thereafter, the control of the system is transferred to the interrupt handler of each of the Operating Systems (OSs).

The interrupt handler of the OS traces the BDF value, which is recorded in the PCI bridges, so as to identify the I/O device, and cooperates with a device driver in running recovery processing through device reset. After error handling is completed, the records in the PCI bridges are deleted.

In the field of server virtualization, for example, Japanese Patent Application Laid-Open Publication No. 2004-220218 is cited as a literature describing a technology referred to as a direct memory access (DMA) address translator. According to the technology, guest OSs running on a hypervisor can directly manipulate an I/O device, and a high-speed I/O device manipulation can be realized.

### BRIEF SUMMARY OF THE INVENTION

In the virtualized environments, an architecture in which PCI passthrough (which may be called device passthrough) is used to allow a virtual machine, which supports the aforesaid AER, to employ or recover I/O devices is required. In the architecture, if an error occurs in the I/O device, the virtual machine identifies the I/O device, and recovers the I/O device by resetting the I/O device using a device driver in the virtual machine.

As mentioned above, according to the AER, if an error occurs in an I/O device, error information is concurrently recorded in plural PCI bridges disposed on the way. In contrast, if no error occurs in the I/O device, the error information is absent from the PCI bridges. Specifically, when the I/O device and PCI bridges disposed on the way are seen by a virtual machine, both the I/O device and PCI bridges have the error information, or neither the I/O device nor PCI bridges have the error information. In other words, when seen by the virtual machine, the I/O device alone or PCI bridges alone cannot have the error information.

An object of the present invention is to address the foregoing problems and to provide a computer system, in which pieces of error information on a device seen by a virtual machine do not become inconsistent with each other, and a control method for the computer system.

In order to accomplish the above object, according to an aspect of the present invention, there is provided a computer system that includes a processor (processing unit (CPU)), a memory, and a device tree including physical bridges and devices. In the memory, virtual machines capable of mutually independently acting and a hypervisor which manages the virtual machines are existent. The physical bridge has a memory space in which information specifying the device is recorded. The virtual machine (VM) includes a virtual CPU, a virtual memory, and a virtual device tree including virtual bridges and virtual devices. The virtual bridge has a virtual memory space in which information specifying the device is recorded. The hypervisor includes a virtual bridge modification program that modifies the information recorded in the virtual bridge.

In order to accomplish the above object, according to an aspect of the present invention, there is provided a control method for a computer system that has a processor, a memory, and a physical device tree including physical bridges and devices. In the memory, plural virtual machines capable of mutually independently acting and a hypervisor that manages the virtual machines are stored. The virtual machine includes a virtual processor, a virtual memory, and a virtual device tree including virtual bridges and virtual devices. The physical bridge has a memory space in which information specifying the device is recorded. The virtual bridge has a virtual memory space that is an area in which information specifying the virtual device is recorded. At least one device is associated with each of the virtual devices. A virtual bridge modification program that modifies information in the virtual memory space of the virtual bridge is included in the hypervisor. If an interrupt is issued from one of the devices to the hypervisor, the hypervisor activates the virtual bridge modification program.

According to aspects of the present invention, there is provided a computer system capable of making pieces of information, which are held in a virtual bridge and virtual device within a virtual PCI tree, consistent with each other.

### BRIEF DESCRIPTION OF THE DRAWINGS

FIG. 1 is a diagram showing an example of a virtual computer system configuration in accordance with a first embodiment;

FIG. 2 is a diagram showing an example of a virtual PCI tree structure in the first embodiment;

FIG. 3 is a diagram showing an example of a virtual memory structure in the first embodiment;

FIG. 4 is a diagram showing an example of a structure of a physical-virtual device mapping table in the first embodiment;

FIG. 5 is a diagram showing an example of a structure of a virtual bridge table in the first embodiment;

FIG. 6 is a diagram showing an example of a flowchart of an overall control method in the first embodiment;

FIG. 7 is a diagram showing an example of a flowchart, which describes a control method to be implemented in case an interrupt occurs, in the first embodiment;

FIG. 8 is a diagram showing an example of a flowchart describing a PCI tree emulation control method in accordance with the first embodiment;

FIG. 9 is a diagram showing an example of a flowchart describing a virtual bridge emulation control method in accordance with the first embodiment;

FIG. 10 is a diagram showing an example of a flowchart describing a virtual device emulation control method in accordance with the first embodiment;

FIG. 11 is a diagram showing an example of a flowchart describing OS processing, which is performed in case an interrupt occurs, in accordance with the first embodiment;

FIG. 12 is a diagram showing an example of a flowchart describing OS processing, which is performed in case an interrupt occurs, in accordance with a second embodiment;

FIG. 13 is a diagram showing an example of a flowchart describing an example of actions of a PCI tree in the second embodiment;

FIG. 14 is a diagram showing an example of a register structure in the first embodiment;

FIG. 15 is a diagram showing an example of a virtual register structure in the first embodiment; and

FIG. 16 is a diagram showing an internal structure of a virtual PCI tree in a third embodiment.

### DETAILED DESCRIPTION OF THE INVENTION

Referring to the drawings, embodiments of the present invention will be described below.

### First Embodiment

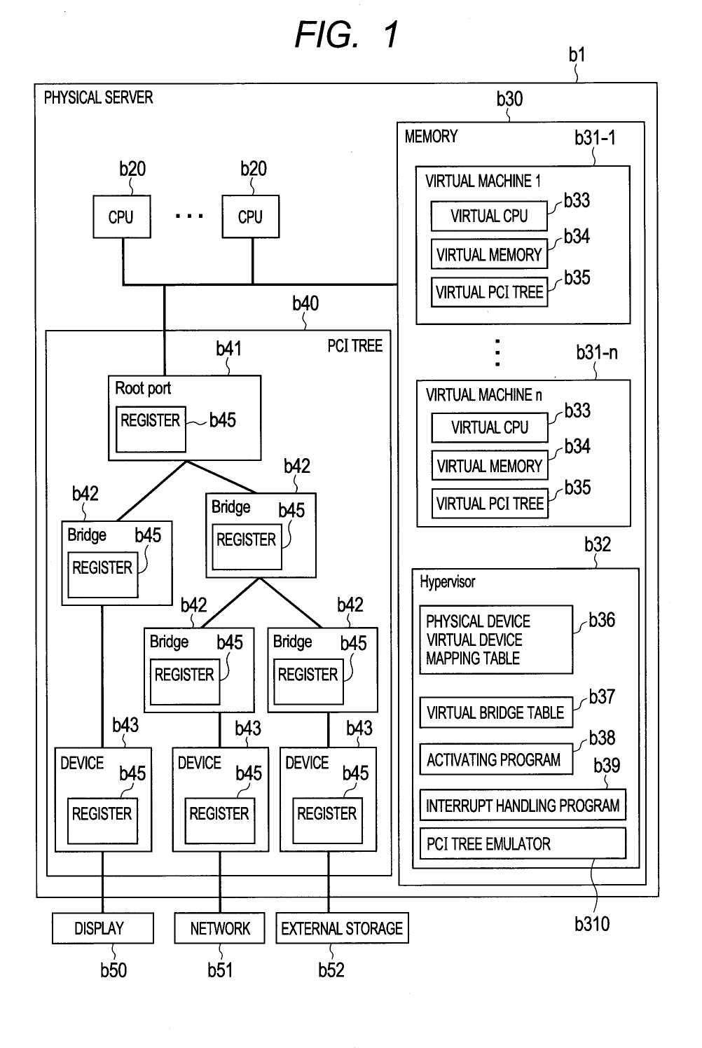

In relation to the present embodiment, an example of a configuration of a computer system that supports advanced error reporting (AER) under a virtualized environment will be described in conjunction with FIG. 1 to FIG. 11.

FIG. 1 shows an example of a typical configuration of a physical server employed in constructing a computer system in accordance with the present embodiment. One central processing unit (CPU) or plural CPUs b20 that function as a processor, a memory b30, and a PCI tree b40 that is a physical device tree are included in a physical server b1.

The physical PCI tree b40 includes a root port b41, bridges b42, and devices b43. The devices b43 are connected to a display b50, network b51, and external storage b52. The pieces of equipment to which the devices b43 are connected are not limited to the display b50, network b51, and external storage b52. To any of the display, network, and external storage, the devices b43 may not be connected. In addition, plural pieces of one type of equipment may be connected. For example, the plural devices b43 may be connected onto the network b51, or any I/O device may not be connected to the display b50. The device b43 is connected to one of the bridges b42 or to the root port b41, but are neither connected to the plural bridges b42 nor connected to each of the bridge b42 and root port b41. The number of paths linking each of the devices b43 with the root port b41 is only one. Each of the root port b41, bridges b42, and devices b43 includes a register that is an area in or from which data can be written or read. The register b45 has an error record space to be described later. It is not necessary to read or write data from or in all areas in the register b45. For example, the register b45 may have an area from which data can be read but in which data cannot be written.

The bridges b42, root port b41, and devices b43 are assigned physical bus/device/function (BDF) values that are different values. In contrast, the bridges b42, root port b41, and devices b43 to which the different physical BDF values are assigned are regarded as different components. For example, equipment may have a PCI tree in which the root port b41 and plural bridges b42 cannot be physically separated from one another. In this case, the root port b41 and bridges b42 are regarded as different components. The devices b43 may not be able to be physically separated from each other but may be assigned different BDF values. In this case, the devices b43 are regarded as different components. Hereinafter, for convenience' sake, the root port b41, bridges b42, and devices b43 are identified from one another on the basis of the BDF values. However, any other discriminating method may be adopted as long as each of the root port, bridges, and devices can be identified. In this case, other values that can specify respective components are read for the BDF values. Hereinafter, due to the relationship of connection of each of the devices b43 to each of the bridges b42, a direction approaching the root port b41 shall be regarded as an upward direction, and a direction receding from the root port b41 shall be regarded as a downward direction. In other words, the root port b41 is disposed at the uppermost position, and it is impossible to go down from each of the devices.

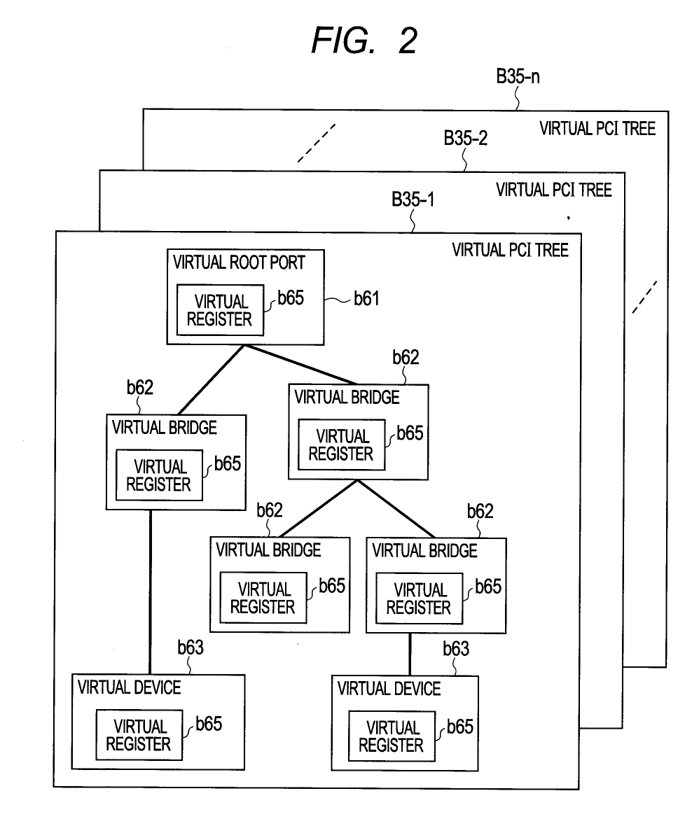

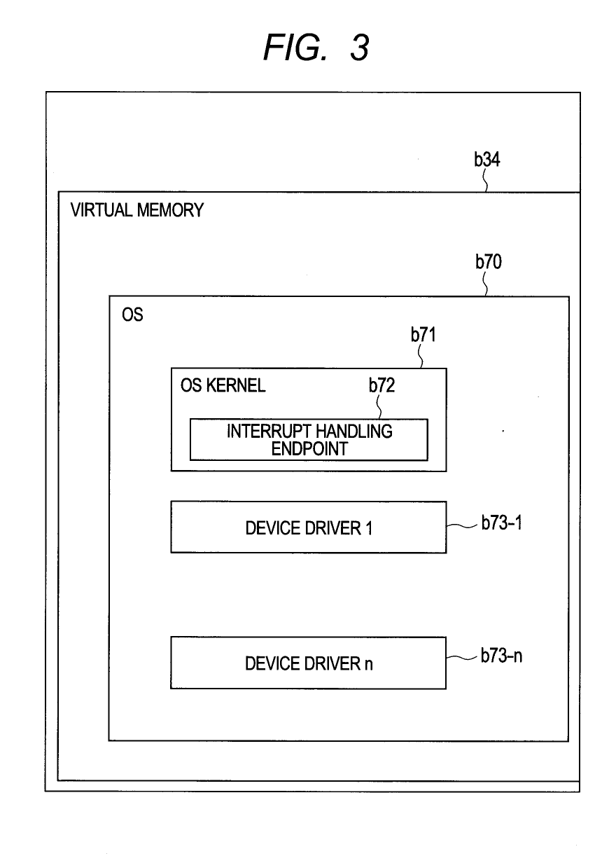

In the memory b30, pieces of information on virtual machines b31-1 to b31-n and on a hypervisor b32 are stored. In each of the virtual machines b31-1 to b31-n, at least pieces of information on a virtual CPU b33, virtual memory b34, and virtual PCI tree b35 are stored. In addition, other information may be stored. Further, the pieces of information may be disposed at any area in the memory b30. The information stored in the virtual PCI tree b35 will be described later in conjunction with FIG. 2, and the information stored in the virtual memory 35 will be described later in conjunction with FIG. 3.

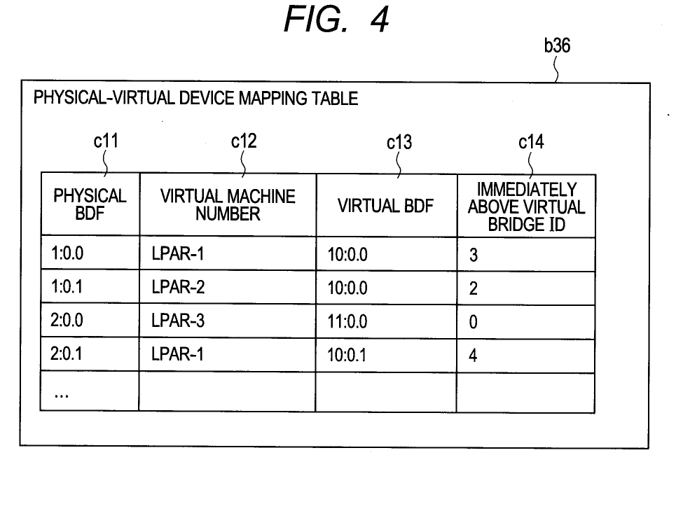

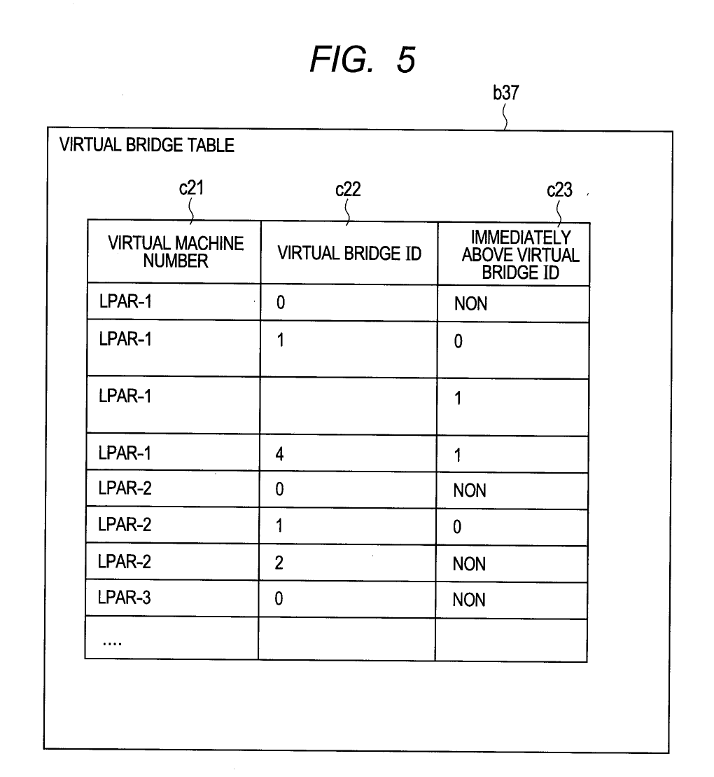

In the hypervisor b32, a physical-virtual device mapping table b36, virtual bridge table b37, activating program b38, interrupt handling program b39 that functions as a virtual PCI bridge control program, and PCI tree emulator b310 are stored. Any other information may be contained in the hypervisor b32. The physical-virtual device mapping table b36 will be detailed later in conjunction with FIG. 4, and the virtual bridge table b37 will be detailed later in conjunction with FIG. 5.

FIG. 2 shows in detail an example of a virtual PCI tree b35 in the first embodiment. The virtual PCI trees b35-1 to b35-n are associated with the aforesaid virtual machines b31-1 to b31-n. For convenience' sake, FIG. 2 shows only the inside of the virtual PCI tree b35-1. However, the virtual PCI tree b35-2 to b35-n have similar tree structures associated with the virtual machines b31-2 to b31-n. Hereinafter, the virtual PCI tree b35-1 is regarded as a typical example in order to describe the virtual PCI tree b35.

In FIG. 2, the virtual PCI tree b35 includes a virtual root port b61, virtual bridges b62, and virtual devises b63. The virtual root port b61 and each of the virtual bridges b62 have a virtual register b65. The inside of the virtual register b65 will be detailed later in conjunction with FIG. 15. The virtual devices b63 are connected to the virtual root port b61 via the virtual bridges b62. Alternatively, the virtual devices b63 may be connected directly to the virtual root port b61. However, the number of paths that link each of the virtual devices with the virtual root port b61 is only one. One of the virtual devices b63 is associated with one of the devices b43. A concrete associating method will be detailed later in conjunction with FIG. 4.

As shown in FIG. 2, each of the virtual PCI trees b35-1 to b35-n in the respective virtual machines b31-1 to b31-n includes different virtual bridges b62, a different virtual root port b61, and different virtual devices b63. In the virtual PCI tree b35 in each of the virtual machines b31-1 to b31-n, the virtual root port b61, virtual bridges b62, and virtual devices b63 are assigned virtual BDF values that are different from one another. Hereinafter, in the virtual PCI tree, from the viewpoint of the relationship of connection, a direction approaching the virtual root port b61 shall be regarded as an upward direction, and a direction receding from the virtual root port b61 shall be regarded as a downward direction. Namely, in each of the virtual PCI trees, the virtual root port b41 is disposed at the uppermost position, and it is impossible to go down from each of the virtual devices b63.

FIG. 3 is a diagram detailing the virtual memory b34 shown in FIG. 1 and included in the present embodiment. In the virtual memory b34, at least an OS b70 that controls the virtual machine b31 resides. The OS b70 may or may not act in an environment that is not virtualized. In the OS b70, at least an OS kernel b71 and device drivers b73-1 to b73-n are existent. An interrupt handling endpoint b72 that, when the hypervisor b32 virtually issues an interrupt to the OS 70, identifies the factor of the interrupt and handles the interrupt is included in the OS kernel b71. As the device drivers b73-1 to b73-n, different device drivers are used based on the types of virtual devices b63. Alternatively, the same device driver may be used to manipulate the plural virtual devices b63. For manipulating one of the virtual devices b63, plural ones out of the device drivers b73-1 to b73-n may be employed.

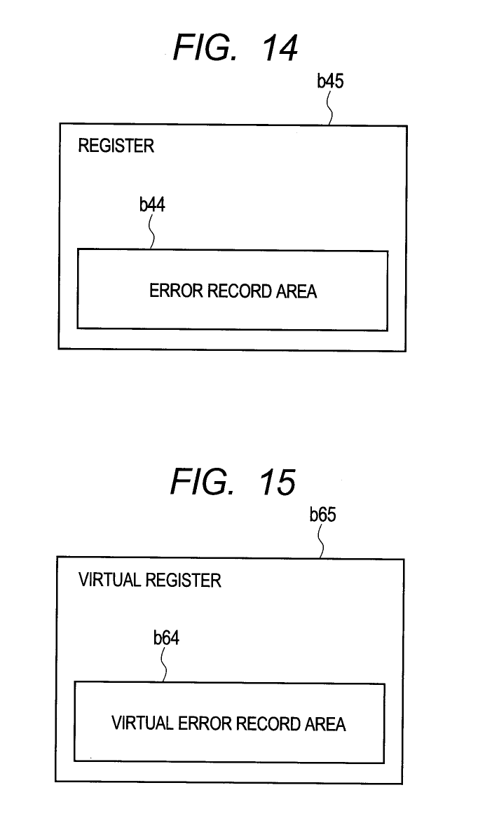

FIG. 14 is a diagram showing a structure of the register b45 in the present embodiment. In each of the registers b45, at least an error record space b44 exists. As for the format for the error record space, for example, error information may be written in a format independent of a device, for example, in a format supported by the AER, or may be written in a device-dependent format.

FIG. 15 is a diagram showing a structure of the virtual register b65 included in the present embodiment. In the virtual register b65, at least a virtual error record space b64 exists. As for the format for the virtual error record area, error information may be written in a format independent of a device, for example in a format supported by the AER, or may be written in a device-dependent format.

FIG. 4 shows an example of the physical-virtual device mapping table b36 included in the present embodiment. FIG. 5 shows an example of the virtual bridge table b37. Elements employed in common in the physical-virtual device mapping table b36 and virtual bridge table b37 will be briefed below.

Each of a virtual machine number c12 in the physical-virtual device mapping table b36 and a virtual machine number c21 in the virtual bridge table b37 specifies one of the virtual machines b31-1 to b31-n. The virtual machine numbers may be information written in any format as long as the information can specify one of the virtual machines b31-1 to b31-n. A character string or integer value that indicates a virtual machine name is thought to be generally adopted. Alternatively, any other value such as an IP address independently allocated to each virtual machine may be employed.

Next, an immediately above virtual bridge ID c14 in the physical-virtual device mapping table b36, and a virtual bridge ID c22 and immediately above virtual bridge ID c23 in the virtual bridge table b37 will be described below. Each of the IDs is information that uniquely specifies the virtual bridge b62 or virtual root port b61 in the virtual PCI tree b35 included in any of the virtual machines b31-1 to b31-n. Specifically, the virtual bridge ID c22 in the virtual bridge table b37 is information that uniquely specifies the virtual bridge b62 or virtual root port b61 included in one of the virtual machines b31-1 to b31-n designated with the virtual machine number c12. In addition, the virtual bridge ID c22 or immediately above virtual bridge ID c23 in the virtual bridge table b37 is information that uniquely specifies the virtual bridge b62 or virtual root port b61 included in one of the virtual machines b31-1 to b31-n designated with the virtual machine number c21.

In the foregoing tables, for convenience' sake, the virtual root port b61 is managed together with the virtual bridges b62. Alternatively, the virtual root port b61 may be managed using another table in the same manner as the virtual bridges b62 are. As for the format for a value, information in any format may be adopted as long as the information uniquely specifies the virtual bridge b62 or virtual root port b61 in any of the virtual machines b31-1 to b31-n. For example, an address value in the memory b30 may presumably be adopted.

Next, the physical-virtual device mapping table shown in FIG. 4 will be detailed below.

The physical-virtual device mapping table b36 includes, for example, a physical BDF value c11 that is information specifying a device, a virtual machine number c12, a virtual BDF value c13 that is information specifying a virtual device, and an immediately above virtual bridge ID c14. Each row in the physical-virtual device mapping table b36 is associated with one of the physical devices b43 in the PCI tree b40. One physical device b43 is associated with a virtual device b63 in one virtual PCI tree b35 out of the virtual PCI trees b35 included in the respective virtual machines b31-1 to b31-n. In other words, in the present embodiment, neither the virtual device b63 associated with one physical device b43 simultaneously exists in the plural virtual machines nor one physical device b43 is associated with two virtual devices b63 included in one virtual machine.

The physical BDF value c11 shall be used as an example of information which the hypervisor uses to identify each of the devices b43. Therefore, the physical BDF value is a unique value in the physical-virtual device mapping table b36. However, any other value may be adopted as long as the hypervisor can identify the device b43 with the value.

The virtual machine number c12 specifies one of the virtual machines b31-1 to b31-n which employs the device b43. The format for the value has been described before.

The virtual BDF value c13 is used to designate how a device looks at one of the virtual machines b31-1 to b31-n designated with the virtual machine number c12. The virtual BDF value is recorded in the virtual error record space b64 in the virtual bridge b62 or root port b61. The value may therefore be written in any format as long as it can be recorded in the virtual error record space b64.

The immediately above virtual bridge ID c14 is a value signifying to which of the virtual bridges b62 the associated virtual device b63 is connected. The format for the value has been described previously.

FIG. 5 shows an example of the virtual bridge table.

The virtual bridge table b37 includes, for example, a virtual machine number c21 that is information specifying a virtual machine, a virtual bridge ID c22 that is information specifying a virtual bridge, and an immediately above virtual bridge ID c23 that is information specifying a virtual bridge located immediately above each of the virtual bridges. In each row in the virtual bridge table b37, both the virtual machine number c21 and virtual bridge ID c22 will not take on the same value.

The virtual machine number c21 signifies to which of the virtual machines b31-1 to b31-n each of the virtual bridges b62 or the virtual root port b61 belongs. The format for this value has been described previously.

The virtual bridge ID c22 is a numerical value that uniquely specifies the virtual bridge b62 or virtual root port b61 in the virtual PCI tree b35 in one of the virtual machines b31-1 to b31-n designated with the virtual machine number b21. The format for the value has been described previously.

The immediately above virtual bridge ID c23 is used to designate the virtual bridge b62, which is located immediately above the virtual bridge b62 or virtual root port b61 designated with the virtual machine number b21 and virtual bridge ID b22, or the virtual root port b62. Supposing what is designated with the virtual bridge ID b22 is the virtual root port b61, the virtual bridge b62 close to the virtual root port b61 or the virtual root port b61 does not exist. Therefore, a value signifying that the virtual bridge or virtual root port does not exist is specified as the immediately above virtual bridge ID c23.

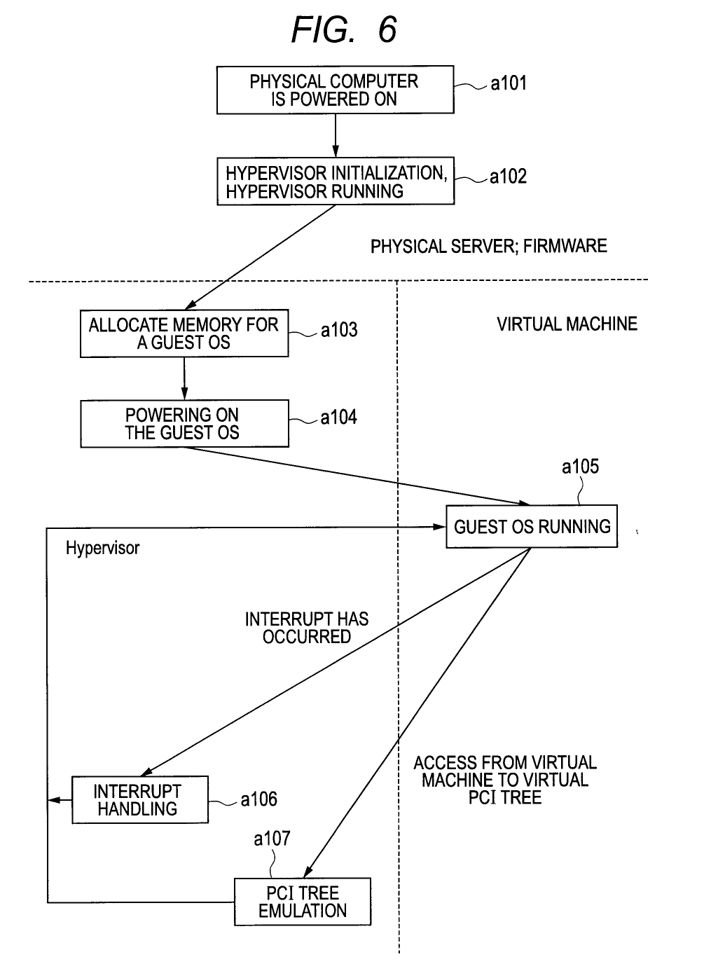

Referring to FIG. 6, an example of actions to be performed in the computer system in accordance with the present embodiment will be summarized below.

The actions to be performed in the computer system are initiated when a physical computer b1 is started up (a101). A concrete method of starting up the physical computer b1 is, for example, to turn on the power switch of the computer system, or to explicitly describing a program that initiates actions of a virtual computer system subsequently to actual startup. However, since the startup method has nothing to do with the gist of the present embodiment, the startup method will not be described any more.

A physical server started up at step a101 initializes the hypervisor b32, and runs the hypervisor b32 (a102). Initialization of the hypervisor b32 is intended mainly to preserve the memory, and to set instructions in the CPU b20 so that if an interrupt is issued from the device b43 or the like to the hypervisor, the interrupt handling program b39 that functions as a virtual bridge modification program can be activated. However, any other processing may be performed as the initialization. For example, since a mode in which the hypervisor acts is supported by a specific CPU b20, the mode in which the hypervisor b32 acts may be selected at the step of the initialization processing.

The hypervisor b32 initialized at step a102 uses the activating program b38 to preserve the memories in the virtual machines b31-1 to b31-n (a103). However, the hypervisor b32 need not always preserve the memories using the activating program b38. When the hypervisor b32 is run, the physical computer may presumably autonomously preserve the memories of the virtual machines. In addition, all the memories of the virtual machines b31-1 to b31-n need not be preserved, but the memory of the virtual machine that will be actually started up may be preserved.

Thereafter, the hypervisor b32 starts up the virtual machines b31-1 to b31-n whose memories are preserved at step a103 (a104). All of the virtual machines b31-1 to b31-n whose memories have been preserved need not be started up, but some of them may be started up.

When the virtual machines b31-1 to b31-n are started up at step a104, the OS b70 is activated within each of the virtual memories of the virtual machines (a105). The OS b70 initializes the virtual memory so that it can act. Part of the initialization may be performed by the hypervisor b32. In this case, for example, when the virtual machines b31-1 to b31-n are initialized at step a102 in order to preserve the memories, setting may presumably be performed. When the OS b70 begins acting in each of the virtual machines b31-1 to b31-n, the hypervisor b32 is called at two timings. One of the timings is the timing when an interrupt is issued from the device b43 or the like to the hypervisor b32, and the other timing is the timing when access is given from any of the virtual machines b31-1 to b31-n to the virtual PCI tree.

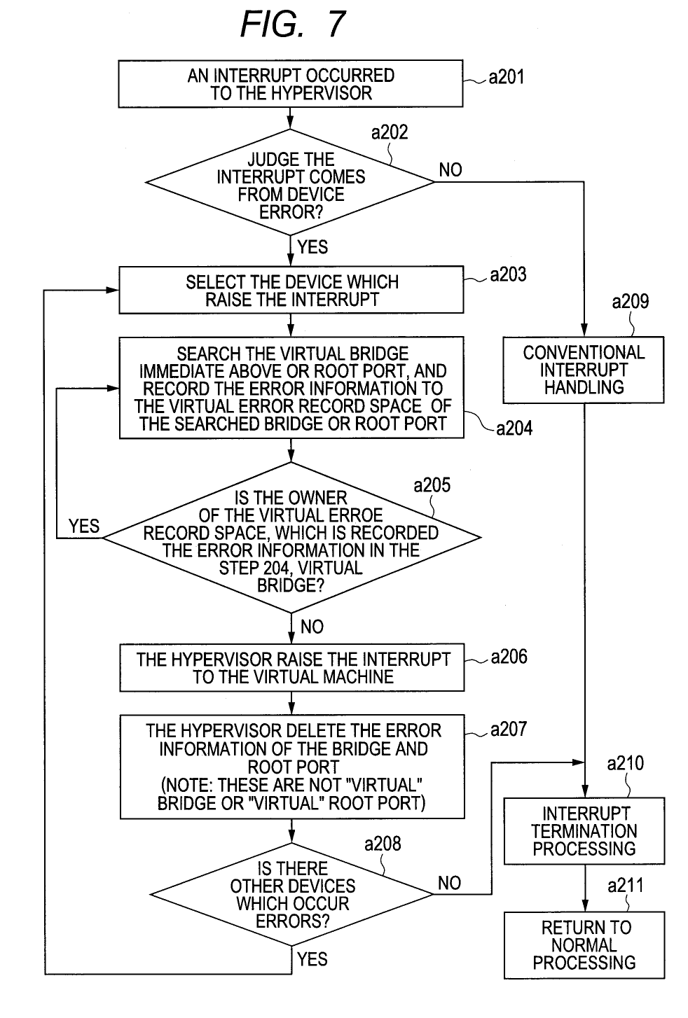

If an interrupt is issued from the device b43 or the like to the hypervisor b32 at step a105, the interrupt handling program b39 in the hypervisor b32 handles the interrupt (b106). A concrete procedure of processing for coping with the interrupt will be described later in conjunction with FIG. 7.

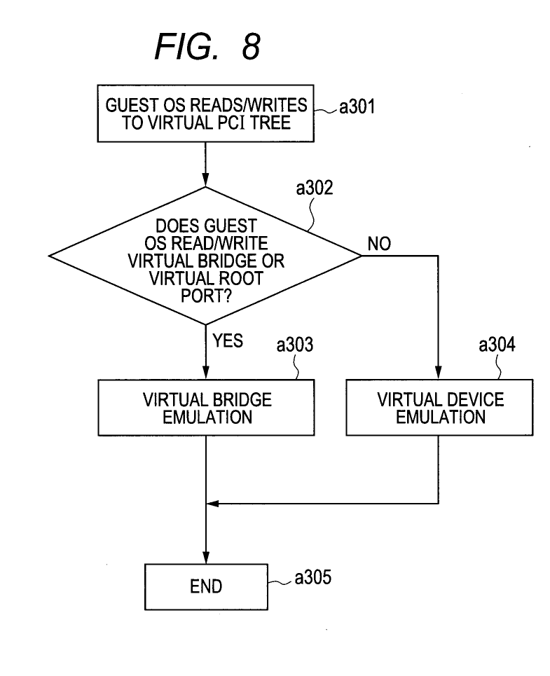

If access is given from any of the virtual machines b31-1 to b31-n to the virtual PCI tree at step a105, the hypervisor activates the PCI tree emulator b310. Detailed actions to be performed by the PCI tree emulator b310 will be described later in conjunction with FIG. 8 to FIG. 10.

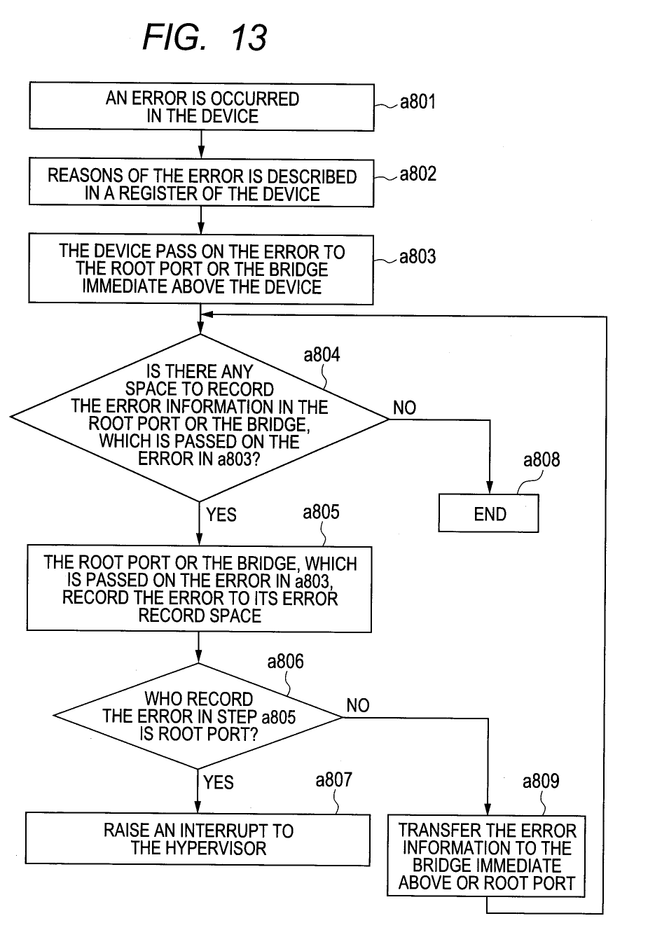

Referring to FIG. 13, a description will be made of an example of actions to be presumably performed in the physical PCI tree b40 in case an error occurs in a physical device.

The actions are initiated at the timing when an error occurs in one of the devices b43 shown in FIG. 1 (a801). If an error occurs in the device b43, the device b43 having the error occurred therein internally records the contents of the error (a802). The format for the contents of the error may be independent of a device similarly to the format supported by AER. Alternatively, the contents of the error may be preserved in a format specific to the device.

When the device b43 in which an error has occurred is connected to the bridge b42, the device b43 posts the error to the connected bridge b43. When connected to the root port b41, the device b43 posts the error to the root port b41 (a803).

The bridge b42 or root port b41 to which an error is posted at step a803 checks itself to see if there is room for recording error information internally (a804). This is performed on the assumption that the error has occurred in plural devices b43 simultaneously or at close times. The AER has such a specification that if the error occurs in the plural devices, the AER records only the first one of the errors. If the error has occurred in any other device, there is no room for recording another error. Incidentally, when the AER has such a specification as to record pieces of error information on plural devices, even if error information is already present, another piece of error information may be able to be recorded.

If it is found at step a804 that there is no room for recording error information, processing is terminated (a808). The AER simply terminates processing. Alternatively, an interrupt may be issued to the hypervisor. If it is found at step a804 that there is room for recording error information, the bridge b42 or root port b41 to which the error is posted at step a803 writes the error information therein (a805). In this case, what is written as the error information is, for example, a bus/device/function (BDF) value that is a numeral which the hypervisor b32 employs to identify and control the device b43. Alternatively, a factor of the error having occurred in the device b43 may be written.

Next, whether error information has been recorded in the bridge b42 or in the root port b41 at step a805 is decided (a806).

At step a806, if the error information is recorded in the root port b41, the root port b41 issues an interrupt to the hypervisor b32 and terminates processing. When the interrupt is issued to the hypervisor b32, the interrupt handling program b38 is activated. An example of actions to be performed in this case will be described below in conjunction with FIG. 7.

If what has error information recorded therein at step a806 is not the root port b41 but is the bridge 42, the error information is transmitted to the bridge b42 located above or the root port b41 (a809). The bridge b42 or root port b41, to which the error information is transmitted, returns to step a804, and decides whether there is room for recording the error information.

Referring to FIG. 7, a description will be made of an example of actions that are described in an interrupt handling program or a virtual bridge modification program and are performed as part of the example of actions which are performed in the physical PCI tree in the present embodiment in case an interrupt occurs in the hypervisor b32. In FIG. 7, processing steps that are equivalent to foregoing steps are performed mainly by the interrupt handling program unless otherwise noted.

The actions are initiated at the timing when an interrupt is issued from the device b43 or the like to the hypervisor b32 (a201). If an interrupt is issued from the device b43 or the like to the hypervisor b32, the interrupt handling program b39 is activated. The interrupt handling program b39 decides whether the factor of the interrupt is a device error (a202). As for a method of deciding whether an interrupt factor is a device error, there is a method of checking all conceivable interrupt factors, and deciding the device error when the interrupt factors other than the device error are not detected. Otherwise, plural interrupt handling programs b39 may be prepared, and the plural interrupt handling programs b39 are switched depending on the interrupt factor.

If a decision is made at step a202 in FIG. 7 that the interrupt factor is not a device error, the interrupt handling program b39 performs conventional interrupt handling (a209). The conventional interrupt handling encompasses processing to be triggered with a timer interrupt from the CPU b20 or processing to be triggered with transmission or reception of data over the network b51. The conventional interrupt handling will not be described in this specification.

If a decision is made at step a202 that an interrupt factor is a device error, the interrupt handling program b39 selects one of the devices b43 in which an error has occurred (a203). Herein, one of the devices is selected on the assumption that an error has occurred in plural devices simultaneously or at very close times. This is because an error in one device is likely to affect the other devices through an electronic circuit in the physical server 1, or because when plural devices b43 are interconnected outside the physical server 1, an error is likely to spread through the outside of the physical server 1. This incident occurs frequently.

Several methods are available in selecting one of devices b43 in which an error has occurred. For example, a method of checking the devices in ascending order of a bus/device/function (BDF) value seen by the hypervisor b32, and searching for an erroneous device is conceivable. In addition, a method of selecting the device b43, which is recorded in the error record space b44 in the root port b41, as a top priority, confirming that no error has occurred in the device b43, and checking the devices b43 in ascending order of the BDF value seen by the hypervisor b32 is conceivable. Herein, the method of selecting the device b43, which is recorded in the error record space b44, as a top priority is adopted in a case where an error in one device b43 affects the other devices b43. This is because the original error in the device b43 has to be handled first.

Using the physical-virtual device mapping table b36 and virtual bridge table b37, error information is entered in the virtual bridge b62, which is located immediately above the device b43, in which an error has occurred and which is selected at step a203, or the virtual bridge b62 selected at step a203, or in the virtual root port b61 selected at step a203 (a204).

To begin which, a method of checking for the virtual bridge b62 or virtual root port b61 located immediately above the device b43 will be described below. Using the physical-virtual device mapping table b36 shown in FIG. 4, a row containing the physical BDF value c11 equal to the physical BDF value of the device b43 is selected. The virtual bridge b62 or virtual root port b61 designated with the combination of the virtual machine number c12 and immediately above virtual bridge ID c14 in the selected row, is the immediately above virtual bridge b62 or virtual root port b61. This is the method of identifying the virtual bridge b62 or virtual root port b61 located immediately above the device b43.

Next, a method of selecting the immediately above virtual bridge b62 or virtual root port b61 on the basis of the virtual bridge b62 or virtual root port b61 selected at this step will be described below. For convenience' sake, the virtual bridge b62 or virtual root port b61 to be selected at this step shall be called an original virtual bridge. A row which contains the virtual machine number c21 and virtual bridge ID c22 that are identical to the virtual machine number and virtual bridge ID of the original virtual bridge is selected from the virtual bridge table b37 shown in FIG. 5. The virtual bridge b62 or virtual root port b61 designated with the combination of the virtual machine number c21 and immediately above virtual bridge ID c23 corresponds to the immediately above virtual bridge b62 or virtual root port b61.

Error information is written in the error record space b64 of the thus selected virtual bridge b62 or virtual root port b61.

Thereafter, whether an area where error information has been written at step a204 is the virtual error record space b64 of the virtual bridge b62 is decided at step a205 in FIG. 7. If the area where error information is written is the virtual error record space b64 of the virtual bridge b62, processing is returned to step a203, and the error information is written in the virtual error record space b64 of the upper-level virtual bridge.

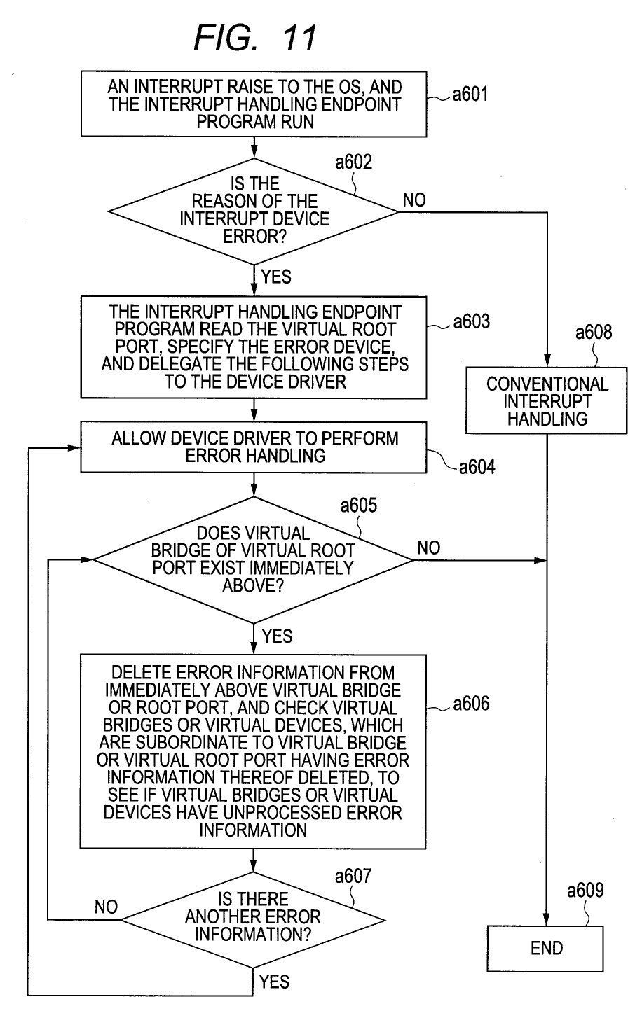

If it is found at step a205 that an area where error information is written is an area in the virtual root port b61, an interrupt is issued to the virtual machines b31-1 to b31-n each of which has the virtual PCI tree b35 in which the virtual root port b61 exists (a206). If the interrupt is issued to the virtual machines b31-1 to b31-n, the Oss b70 in the virtual machines b31-1 to b31-n receive the interrupt and perform interrupt handling. Processing to be performed by the OS will be described later in conjunction with FIG. 11.

After step a206 is completed, error information is deleted from the bridge b42 and root port b41 (a207). This step is necessary to allow error information to remain in a physical bridge in case another error occurs. The step may be performed once at any timing, for example, immediately prior to step a203 or step a206.

After step a207 is completed, the devices are checked to see if there is a device that has not undergone error handling (a208). If there is a device that has not undergone error handling, processing is returned to step a203, and error handling is performed again.

If it is found at step a208 that error handling is completed for all the devices, or if it is found at step a209 that another interrupt handling is completed, interrupt completion processing is performed in order to enable issuance of an interrupt from the device b43 or the like (a209). More particularly, a re-interrupt inhibition bit in the CPU or virtual root port is reset to zero. The re-interrupt inhibition bit is included by hardware in order to guarantee that the same interrupt is not issued during interrupt handling. Supposing the bit is not included, the step may not be performed.

When step a209 is completed, interrupt handling is terminated for all the devices, and ordinary processing is resumed (a210 and a211).

Referring to FIG. 8, PCI tree emulation processing in the present embodiment will be detailed. This processing corresponds to step a107 in FIG. 6, and includes actions to be performed by the PCI tree emulator b310 in the hypervisor b32 shown in FIG. 1. Steps in FIG. 8 are the actions to be performed by the PCI tree emulator b310 unless otherwise noted.

PCI tree emulation processing is triggered with a manipulation performed on the virtual PCI tree b35 by any of the virtual machine b31-1 to b31-n manipulates (a301). More particularly, when it says that the virtual machine manipulates the virtual PCI tree, it means that the virtual machine reads or writes data from or in the register b45 included in the virtual root port b61, virtual bridge b62, or virtual device b63.

First, the PCI tree emulator activated at step a301 decides whether an object of emulation is the virtual bridge b62 or virtual root port b61 (a302).

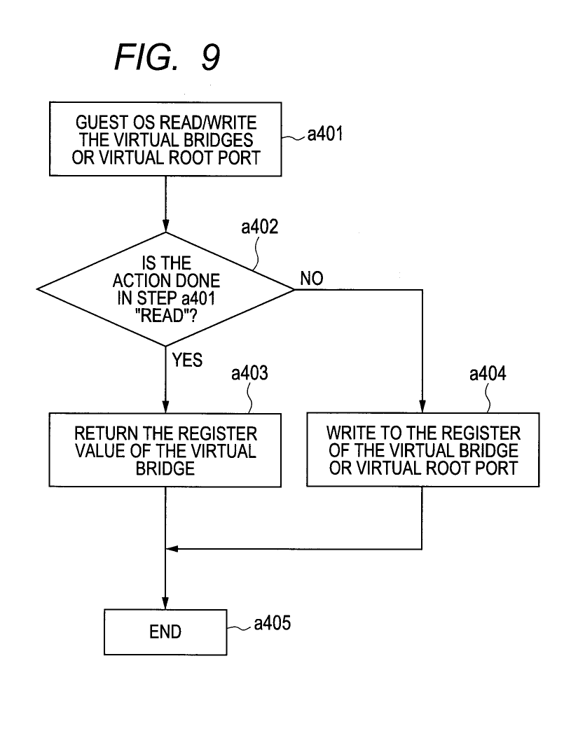

If a decision is made at step a302 that the virtual bridge b62 or virtual root port b61 is to be manipulated, virtual bridge emulation processing is performed (a303). This manipulation will be detailed in conjunction with FIG. 9.

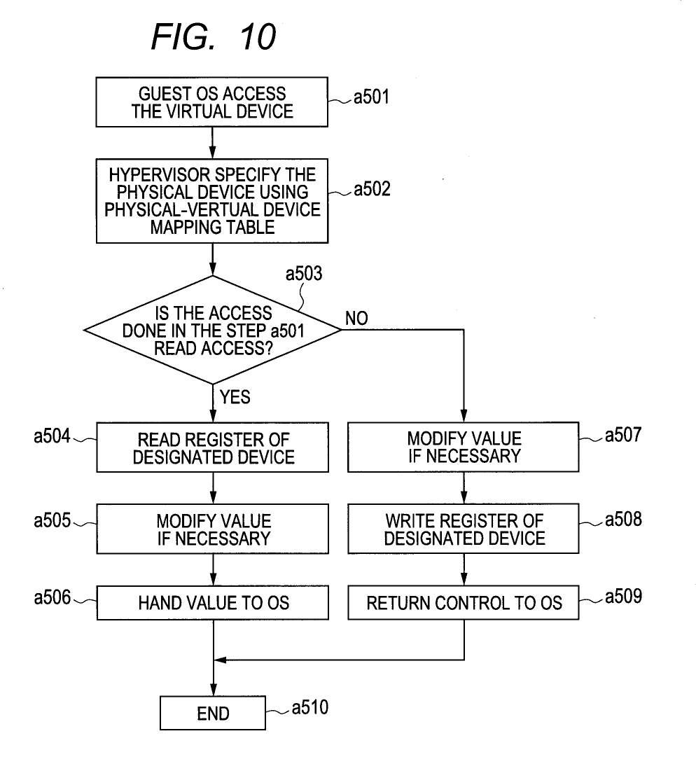

If a decision is made at step a302 that neither the virtual bridge b62 nor virtual root port b61 is manipulated, that is, the virtual device b63 is manipulated, the virtual device emulation processing is performed (a304). This manipulation will be detailed in conjunction with FIG. 10. When the step a303 or a304 is completed, the processing is terminated.

Referring to FIG. 9, virtual bridge emulation processing will be detailed. This processing corresponds to step a303 in FIG. 8, and is initiated when the register b45 in the virtual bridge b62 or virtual root port b61 is manipulated (a401). This processing includes actions to be performed by the PCI tree emulator b310 in the hypervisor b32.

When virtual bridge emulation processing is initiated, whether the manipulation is reading of data is decided (a402). The manipulation to be performed on the virtual bridge b62 or virtual root port b61 is reading or writing of the virtual register b65.

If a decision is made at step a402 that reading the virtual bridge b62 or virtual root port b61 is performed, the PCI tree emulator b310 reads a value in the register in the virtual bridge, and hands the value to the OS (a403). As for a method of handing data to the OS, a method of setting a value at a specific position in, for example, the virtual CPU or virtual memory is cited.

If a decision is made at step a402 that a manipulation is not reading of the virtual bridge b62 or virtual root port b61, or in other words, a manipulation is writing of the virtual bridge b62 or virtual root port b61, the PCI tree emulator b310 sets a value in the virtual register b65 in the virtual bridge (a404). When control is returned to the OS at step a403 or a404, the bridge emulation processing is terminated.

Referring to FIG. 10, virtual device emulation processing will be detailed below. This processing is equivalent to the processing of step a304 in the procedure described in FIG. 8, and is initiated when a manipulation is performed on the register b45 in the virtual device b63 (a501). This processing includes actions to be performed by the PCI tree emulator b310 of the hypervisor b32.

When virtual device emulation processing is initiated, the PCI tree emulator b310 uses the physical-virtual device mapping table shown in FIG. 4 to decide with which of the devices b43 the virtual device b63 that is an object of a manipulation is associated (a502). More particularly, the virtual machine number c12 is referenced in order to acquire a value with which one of the virtual machines b31-1 to b31-n whose virtual device b63 is the object of a manipulation is designated. The virtual BDF value c13 is referenced in order to acquire the BDF value of the virtual device b63 in the one of the virtual machines b31-1 to b31-n, and the physical BDF value c11 in the same row is referenced in order to identify the physical device b43.

Thereafter, whether the manipulation is reading of data is decided (a503). The manipulation to be performed on the virtual device b61 is reading or writing of the virtual register b65.

If it is found at step a503 that a manipulation is reading of the register b65 in the virtual device b63, the PCI tree emulator b310 reads the register b45 in the device a43 identified at step a502 (a504). For example, if the manipulation is intended to read an address α in the virtual register b65 of the virtual device b63, the address α in the register b45 of the device b43 is read.

The PCI tree emulator b310 may modify a value read at step a504 (a505). This is intended to hide a value in a certain register b45 which should not be seen directly by a virtual machine. However, when the contents of all registers are seen as they are, this processing can be omitted, and the value read at step a503 is used as it is.

The PCI tree emulator b310 hands the value, which has been modified at step a505, to the OS b70 in one of the virtual machines b31-1 to b31-n which has caused this processing to be initiated (a506).

If it is found at step a503 that a manipulation is not reading of the register b65 in the virtual device b63, or in other words, that the manipulation is writing of the register b65 in the virtual device b63, the PCI tree emulator b310 modifies a value written in the register b45 of the device a43 identified at step a502 (a507). This step is performed when, for example, the value in the register b45 of the device b43 should not be modified. If the value need not be modified, this step is not performed but the value is used as it is.

When step a507 is completed, the value modified at step a507 is written in the register b45 of the device a43 identified at step a502 (a508). For example, β is written at the address α in the virtual register b65 of the virtual device b63. If β is modified into β′ at step a507, β′ is written at the address α in the register b45 of the device b43.

When step a508 is completed, the PCI tree emulator b310 returns control to the OS b70 of one of the virtual machines b31-1 to b31-n which has caused this processing to be initiated (a509).

When step a507 or a509 is completed, the virtual device emulation processing is terminated (a510).

FIG. 11 describes what actions are performed in the OS b70 in case an interrupt occurs in the OS b70 in the virtual memory b34 of each of the virtual machines 31-1 to 31-n shown in FIG. 3 and included in the computer system of the present embodiment. The actions are performed when an interrupt is issued to the OS b70 at step a206 in FIG. 7.

The actions are triggered with an interrupt issued to the OS b70 and the interrupt handling endpoint b72 is activated (a601). In general, the OS can select a program that is activated in response to an interrupt.

Thereafter, the interrupt handling endpoint b70 decides whether the interrupt stems from a device error (a602). If the interrupt stems from a device error, the OS may activate a special interrupt handling endpoint b70. In this case, since it is apparent that the interrupt stems from a device error, this step may not be executed.

If it is found at step a602 that the interrupt factor is not a device error, the OS performs conventional interrupt handling (a608). As for another interrupt, for example, a timer interrupt is cited. This specification does not detail handling of the time interrupt.

If it is found at step a602 that the interrupt factor is a device error, the OS reads device error information left at the virtual root port b61, identifies the virtual device b62 in which the error has occurred, and hands control to any of the device drivers b73-1 to b73-n shown in FIG. 3 (a603).

Any of the device drivers b73-1 to b73-n assigned handling of the virtual device b63, in which an error has occurred, at an immediately preceding step performs error handling (a604). As an example of the error handling, resetting a register value is conceivable. Incidentally, an error handling method depends on each device or device driver, and will therefore not be detailed.

The virtual device b63, virtual bridge b62, or virtual root port b61 which has undergone error handling at the immediately previous step is checked to see if an immediately above virtual bridge is present (a605). This step is identical to an action that is performed at step a204 in FIG. 7 in order to check for an immediately above virtual bridge. However, in the case of a virtual machine, since the virtual PCI tree b35 is directly seen, it is not always necessary to use the physical-virtual device mapping table b36 or virtual bridge table b37. However, the table may be used as it is at step a204.

If it is found at step a605 that the virtual bridge b62 or virtual root port b61 exists immediately above, error information is deleted from the existent virtual bridge b62 or virtual root port b61. The subordinate virtual bridge b62 or virtual device b63 is checked to see if it has error information (a606). If plural errors occur, the first one alone is recorded. Therefore, this step is unnecessary.

Whether another piece of error information is found at step a606 is decided (a607). If another piece of error information is found, handling of the virtual device b63 in which the error has occurred is performed by returning to step a604. If another pieces of error information is not found, processing is returned to step a605, and the immediately above virtual bridge b62 or virtual root port b61 is checked for.

When another interrupt has been handled at step a608, if it is found at step a605 that neither a virtual bridge nor a virtual root port exists immediately above, the processing is terminated (a609). When the processing is terminated, for example, the fact that the handling has been completed may be posted to the hypervisor b32 or an interrupt handling end bit may be set in the virtual root port.

The computer system in accordance with the first embodiment has been described so far. Owing to the configuration and actions, the computer system in which information held in a virtual bridge in a virtual PCI tree and information held in a virtual device therein are consistent with each other can be provided.

### Second Embodiment

A second embodiment is concerned with a computer system that is identical to that of the first embodiment in terms of the fundamental configuration but is different therefrom in terms of actions to be performed in case an interrupt occurs in the OS b70 of any of the virtual machines 31-1 to 31-n.

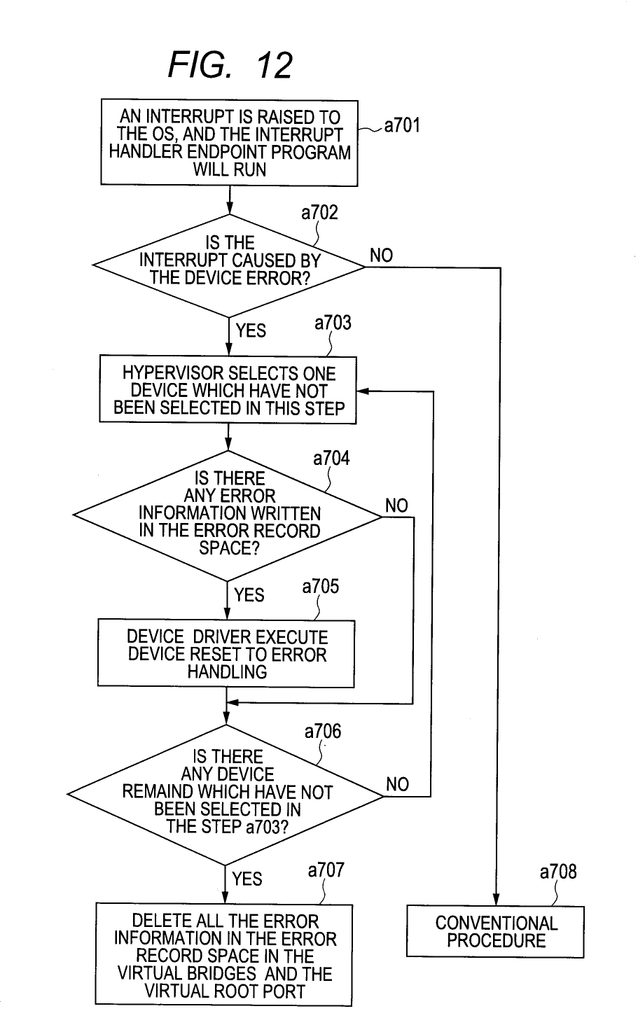

FIG. 12 is a flowchart describing actions to be performed in case an interrupt occurs in the OS b70 in the present embodiment.

According to the present procedure, in case an interrupt occurs in the OS b70 of the virtual memory b34 shown in FIG. 3, the interrupt handling endpoint 62 in the OS b70 is activated in the same manner as it is in the first embodiment (a701).

The activated interrupt handling endpoint b72 decides whether an interrupt stems from a device error (a702). As for a method of deciding whether an interrupt stems from a device error, for example, a method of changing interrupt numbers or reading the state of the virtual root port b62 is conceivable. Normally, in the case where the interrupt number is used to decide whether an interrupt stems from a device error, a device error handling program included in the interrupt handling endpoint is automatically read. Therefore, explicit conditional branching may not be needed.

If it is found at step a702 that an interrupt does not provide error information, the OS b70 performs conventional interrupt handling (a708). For the conventional interrupt handling, for example, communication and timer handling are available. The conventional interrupt handling does not have direct relation to the present embodiment, and a description thereof will therefore be omitted.

If it is found at step a702 that an interrupt provides error information, an arbitrary one of the devices b63 is selected in the present embodiment (a703). As a method of selecting a device, plural methods are conceivable. For example, a method in which the OS of a virtual machine checks PCI devices in ascending order of a virtual bus/device/function (BDF) value that is a value specifying a PCI device, or a method in which the OS checks the PCI devices in descending order of the virtual bus/device/function (BDF) value is cited.

Thereafter, the device b63 selected at step a703 is checked to see if it has error information (a704). Several methods are available in checking the device to see if the device has error information. For example, a method of reading a value in the register b65 of the device is cited. When the OS b70 does not employ the method of checking for a device error, the device error may always be recognized.

If a decision is made at step a704 that there is an error, control is passed to the device driver b73 and the virtual device b63 is reset (a705). Even when the device driver b73 resets the virtual device, the virtual device may not be recovered. In this case, manipulating the virtual device b63 is ceased. Several methods are available in ceasing the manipulation of the virtual device. The power supply of the device may be turned off, and the fact that the power supply of the device is turned off may be posted to the OS b70. The present invention is not concerned with how to cease the manipulation of the virtual device, and a description thereof will therefore be omitted.

If a decision is not made at step a704 that an error has occurred, or if the device driver performs reset processing at step a705, a decision is made whether there is any device that has not been selected at step a703 (a706). Several methods are available in making decision. For example, if an arbitrary device is selected at step a703 by incrementing a virtual bus/device/function (BDF) value, it is confirmed that a larger virtual BDF value does not exist. Since the virtual BDF value is a 16-bit value, up to 65536 searches are needed. If there is a device which has not been selected at step a703, the processing is returned to step a703, and then continued.

If it is found at step a706 that all devices have been searched, all pieces of error information are deleted from the virtual bridges and virtual root port (a707).

A processing flow employed in the computer system in accordance with the second embodiment has been described so far. Owing to the configuration and actions, there can be provided a computer system in which pieces of information held in a virtual bridge and virtual device in a virtual PCI tree are consistent with each other.

### Third Embodiment

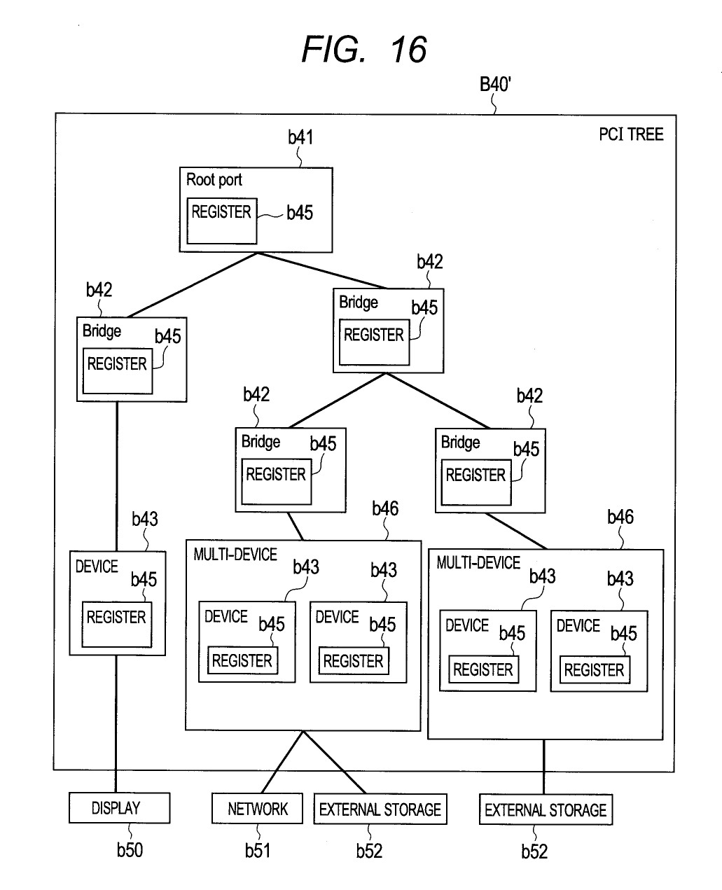

The present embodiment relates to a computer system in which the internal structure of the PCI tree b40 is different from that in the first embodiment. Since fundamental actions are identical to those in the embodiment, only a difference from the structure of the PCI tree b40 shown in FIG. 1 will be described in conjunction with FIG. 16. For convenience' sake, the PCI tree in FIG. 16 shall be called a tree b40′ and thus identified from the PCI tree b40 in FIG. 1.

The PCI tree b40′ in FIG. 16 includes, similarly to the PCI tree b40 in FIG. 1, a root port b41, bridges b42, and devices b43. However, the PCI tree b40′ may include multi-devices b46 in place of the devices b43. The multi-device b46 internally includes plural devices b43. The plural devices b43 in the multi-device b46 may be used for mutually different purposes. For example, the multi-device b46 may be concurrently connected onto a network b51 and to an external storage b52. Otherwise, each of the plural devices b43 in the multi-device b46 may be connected to the external storage b52. The devices b43 in the multi-device b46 include mutually different registers that can be mutually independently read or written. The devices b43 in the multi-device b46 are assigned mutually different BDF values. A hypervisor can perform the same actions on a device irrespectively of whether the device is one of the devices b43 in the multi-device b46 or is the device b43 directly connected to the bridge b42. In the computer system of the present embodiment, a virtual PCI tree also has a structure associated with the structure of the PCI tree b40′, and a description thereof will be omitted.

Even when the PCI tree b40′ shown in FIG. 16 is substituted for the PCI tree b40 in FIG. 1, there can be provided a computer system in which processing can be executed in the same manner as it is in the first or second embodiment and consistency is ensured.

Incidentally, the present invention is not limited to the above-described embodiments but can encompass various variants. For example, the foregoing embodiments are presented for a better understanding of the present invention. The present invention is not limited to a system including all of the described components. In addition, part of the configuration of a certain embodiment may be replaced with the counterpart of the configuration of another embodiment, and part of the configuration of a certain embodiment may be added to the configuration of another embodiment. Further, part of the configuration of each of the embodiments may be provided or replaced with the counterpart of another embodiment, or may be excluded.

What is claimed is:

1. A computer system comprising:
a processor;
a memory; and
a physical device tree including physical bridges and devices, wherein
a plurality of virtual machines capable of mutually independently acting, and a hypervisor that manages the virtual machines are stored in the memory;
the physical bridge has a memory space in which information specifying the device is recorded;
the virtual machine includes a virtual processor, a virtual memory, and a virtual device tree including virtual bridges and virtual devices;
the virtual bridge has a virtual memory space in which information specifying the virtual device is recorded;
at least one of the devices is associated with each of the virtual devices; and
a virtual bridge modification program that modifies information in the virtual bridge is existent in the hypervisor.

2. The computer system according to claim 1, wherein the virtual devices are associated with the devices.

3. The computer system according to claim 1, wherein:
when an interrupt is issued from the device, the hypervisor activates the virtual bridge modification program so as to identify the device that is an interrupt originator, records information in the virtual bridge of the virtual machine with which the originator device is associated, and issues a virtual interrupt to the virtual machine; and
the virtual machine performs interrupt handling.

4. The computer system according to claim 2, wherein:
when an interrupt is issued from the device, the hypervisor activates the virtual bridge modification program so as to identify the device that is an interrupt originator, records information in the virtual bridge of the virtual machine with which the originator device is associated, and issues a virtual interrupt to the virtual machine; and
the virtual machine performs interrupt handling.

5. The computer system according to claim 3, wherein the information that is recorded in the virtual memory space of the virtual bridge and specifies the virtual device is information specifying the virtual device in which an error has occurred.

6. The computer system according to claim 5, wherein as the interrupt handling, the virtual machine identifies a cause of an error in the virtual device in which the error has occurred, and performs processing for coping with the identified error.

7. The computer system according to claim 1, wherein the hypervisor includes a table that associates information, which specifies the device, with information which specifies the virtual device.

8. The computer system according to claim 1, wherein the hypervisor includes a table that associates information which specifies the virtual machine, information which specifies the virtual bridge, and information, which specifies an immediately above virtual bridge, with one another.

9. The computer system according to claim 1, wherein:
the physical device tree further includes a root port disposed between the processor and physical bridges;
the virtual device tree further includes a virtual root port associated with the root port; and
the root port and virtual root port has a memory space in which information on the device is recorded, or a virtual memory space in which information specifying the virtual device is recorded.

10. A control method for a computer system including a processor, a memory, and a physical device tree that includes physical bridges and devices, wherein:
a plurality of virtual machines capable of mutually independently acting, and a hypervisor that manages the virtual machines are stored in the memory;
the virtual machine includes a virtual processor, a virtual memory, and a virtual device tree including virtual bridges and virtual devices;
the physical bridge has a memory space in which information specifying the device is recorded;
the virtual bridge has a virtual memory space that is an area in which information specifying the virtual device is recorded;
at least one of the devices is associated with each of the virtual devices;
the hypervisor includes a virtual bridge modification program that modifies information in the virtual memory space of the virtual bridge; and
when an interrupt is issued from one of the devices to the hypervisor, the hypervisor activates the virtual bridge modification program.

11. The control method for a computer system according to claim 10, wherein the virtual devices are associated with the devices.

12. The control method for a computer system according to claim 10, wherein the hypervisor activates the virtual bridge modification program so as to identify the device that is an interrupt originator, records information in the virtual bridge of the virtual machine with which the identified originator device is associated, and issues a virtual interrupt to the virtual machine; and
the virtual machine performs interrupt handling to cope with the virtual interrupt.

13. The control method for a computer system according to claim 11, wherein:
the hypervisor activates the virtual bridge modification program so as to specify the device that is an interrupt originator, records information in the virtual bridge of the virtual machine with which the identified originator device is associated, and issues a virtual interrupt to the virtual machine; and
the virtual machine performs interrupt handling to cope with the virtual interrupt.

14. The control method for a computer system according to claim 12, wherein the information that is recorded in the virtual memory space of the virtual bridge and specifies the virtual device is information specifying the virtual device in which an error has occurred.

15. The control method for a computer system according to claim 14, wherein as the interrupt handling, the virtual machine identifies a cause of an error in the virtual device in which the error has occurred, and performs processing for coping with the identified error.
